(19) United States
(12) Patent Application Publication
(10) Pub. No.: US 2007/0065213 A1
(43) Pub. Date: Mar. 22, 2007

(54) Printer Capable of Printing on Both Sides of a Printing Media

(76) Inventor: Ku-Feng Liao, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/307,656

(22) Filed: Feb. 16, 2006

(30) Foreign Application Priority Data
Sep. 21, 2005 (TW) 094132652

(51) Int. Cl. B41J 3/60; B65H 15/00

(52) U.S. Cl. 400/188

(57) ABSTRACT

A printer includes a shell, a reversion module, a stick, a roller set, a first sensor, a second sensor, a first motor, and a second motor. The reversion module includes a housing, a first axis, a first gear, a second axis, a second gear, and a plurality of cannelures. The printer feeds a printing media into the reversion module, and drives the rotation of the reversion module to drive the rotation of the printing media so that both sides of the printing media are capable of being printed by the printer. The effect of reversible print without additional reversion of the printing media by bare hands is achieved.

### BACKGROUND OF THE INVENTION

1. Field of the Invention

The present invention relates to a printer, and more particularly, to a printer capable of printing on both sides of a printing media.

2. Description of the Prior Art

In the prior art technology, when a user wishes to perform a printing operation on an unprinted side of a printing media the operation is performed with a single-sided media printer. Specifically, the printing media, having the unprinted side facing up, is fed by the user into the single-sided media printer so that printing on the unprinted side of the printing media can be performed. However, when a user wishes to perform printing on both sides of a printing media (i.e., double sided printing) the operation requires significant user intervention. Specifically, a printed side of the printing media must be reversed manually by the user so that an unprinted side of the printing media faces up. Thereby printing on the unprinted side of the printing media can be performed, and the requirement of printing on both sides (double sides) of the printing media is achieved. When the volume of the desired printing media to be generated in a double-sided fashion is smaller, the time consumed by the user for manually reversing a printed side of the printing media is acceptable. However, when the volume of printing media to be printed in a double-sided fashion is larger, the time consumed by the user for manually reversing a printed side of the printing media thereby performing double-sided printing increases significantly as compared to the time consumed for performing single-sided printing. Therefore, the inconvenient to the users is much greater.

The amount of time and the labor consumed by performing double-sided printing with single-sided media printers is inconvenient. Additionally, since the printing media is reversed manually while the single-sided media printer performing the double-sided printing, the unprinted second side of the printing media easily deviates from a designated position for printing. Therefore, the patterns of both sides of the printing media are inconsistent with each other. This results in the necessity of reprint the double-sided printing causing a waste in the consumed printing media.

### SUMMARY OF THE INVENTION

A printer capable of printing double sides of a printing media comprises a shell having a cannelure disposed on the shell, a reversion module disposed inside the shell in a rotatable manner with respect to the shell, a stick having an end fixed on the cannelure in a slidable manner and having another end fitting a cylindrical structure of the reversion module, a roller set utilized for driving the printing media while the reversion module is fixed within the shell, a first sensor utilized for sensing whether the printing media is driven to a first default position, a second sensor utilized for sensing whether the reversion module is rotated to a second default position, a first motor utilized for driving the stick and the reversion module simultaneously, and a second motor utilized for driving the roller set to drive the printing media.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the present invention printer 100 capable of performing double-sided printing.

FIG. 2 is an exploded view of the reversion module 105 and the roller set 109 of FIG. 1.

FIG. 3 is a diagram of the present invention reversion module 105 of the printer 100 not being rotated nor being at the aforementioned first designated position.

FIG. 4 is a diagram of the reversion module 105 of the printer 100 being rotated a half turn from the aforementioned first designated position to the aforementioned second designated position.

FIG. 5 is a diagram of the present invention reversion module 105 being released from the cylindrical structure 131 by the stick 107 in the printer 100.

FIG. 6 is a diagram of the printing media 119 being directly excluded from the reversion module 105 when there is a defect on the printing media 119.

### DETAILED DESCRIPTION

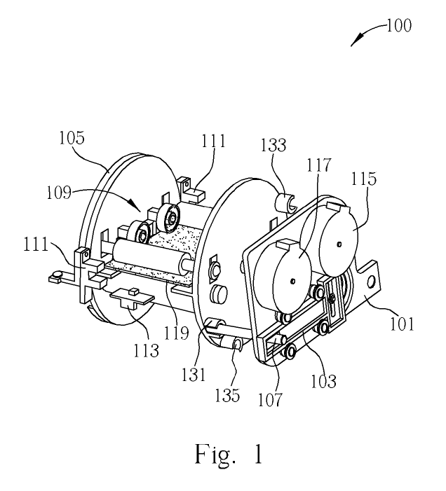

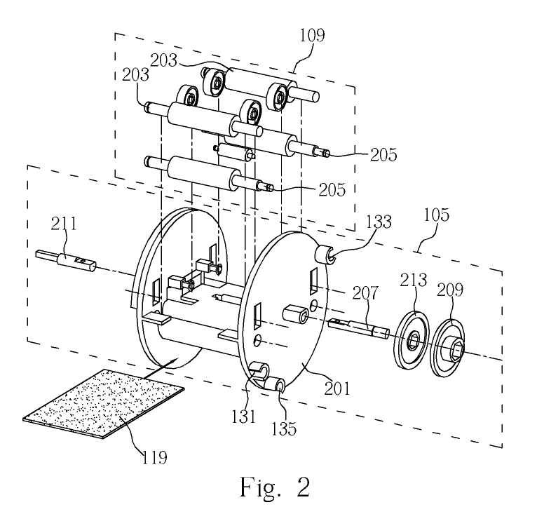

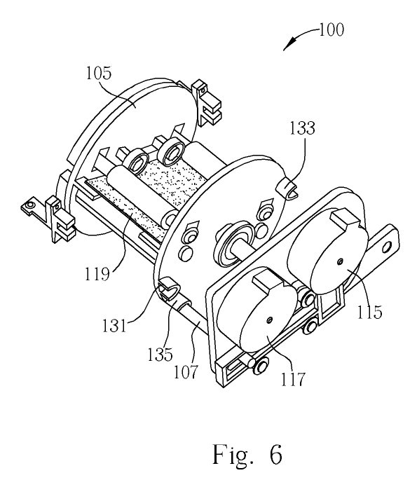

Please refer to FIG. 1, which is a diagram of the present invention printer 100 capable of performing double-sided printing. A printing media 119 is fed into the printer 100. The printing media 119 has a first side and a second side. The first side of the printing media 119 is printed. The second side of the printing media 119 is not printed yet. In view of FIG. 1, the first side of the printing media 119 faces up, and the second side of the printing media 119 faces down. The first side and the second side of the printing media cannot be clearly shown in FIG. 1 so please see FIG. 2 for a clear illustration. The printer 100 comprises a shell 101 with a cannelure 103 disposed on the shell 101, a reversion module 105 with cylindrical structures 131,133,135 disposed on the reversion module 105, the reversion module 105 being disposed inside the shell 101 in a rotatable manner with respect to the shell 101, a stick 107 having one end fixed on the cannelure 103 in a slidable manner and having another end fixed on the cylindrical structures 131, 133, or 135, a roller set 109, a first sensor 111, a second sensor 113, a first motor 115, and a second motor 117. The reversion module 105 is used to drive a rotation of the printing media 119 by a rotation of the reversion module 105 itself when the printing media 119 is fixed inside the reversion module 105. The stick 107 is used to fix or release the reversion module 105. When the stick 107 is fixed on one of the cylindrical structures 131, 133, and 135 of the reversion module 105, the reversion module 105 is fixed by the stick 107 and is thus not able to be rotated. When the stick 107 is not fixed on one of the cylindrical structures 131, 133, and 135 of the reversion module 105, the reversion module 105 is released by the stick 107 and is thus able to be rotated. The roller set 109 is used to drive the printing media 119 when the reversion module 105 is fixed inside the shell 101. The first sensor 111 is used to sense whether the printing media 119 is driven to a first designated position. The second sensor 113 is used to sense whether the reversion module 105 is rotated to a second designated position. The first motor 115 is used to drive a rotation of the reversion module 105 and a slide of the stick 107 simultaneously. The second motor 117 is used to drive the roller set 109 for driving a movement of the printing media 119. When the reversion module 105 is rotated to the second designated position, the stick 107 is fixed on the cylindrical structure 133 so that the reversion module 105 is fixed again and is not able to be rotated. The use of the cylindrical structure 135 will be explained in FIG. 6. Additionally, before the printing media 119 is fed into the reversion module 105, the first side of the printing media 119 is printed. Therefore, the aim of the present invention is to reverse the printing media 119 so that the second side of the printing media 119 faces in a direction that the first side of the printing media 119 was facing (i.e., the aim is to reverse the printing media 119 so that the second side of the printing media 119 faces up).

Please refer to FIG. 2, which is an exploded view of the reversion module 105 and the roller set 109 of FIG. 1. The reversion module 105 comprises a housing 201, a first axis 207 coupled to the housing 201, a first gear 209 coupled to the first motor 115 in FIG. 1 and the first axis 207, a second axis 211 coupled to the housing 201, a second gear 213 coupled to the second motor 117 in FIG. 1, the second axis 211, and the cylindrical structures 131,133,135 in FIG. 1. The roller set 109 comprises two first rollers 203 fixed on the housing 201, two second rollers 205, which are disposed beneath the first rollers 203 and are coupled to the housing 201 and the first motor 117 of FIG. 1. Moreover, when the printing media 119 is fed into the reversion module 105, the first rollers 203 and the second rollers 205 are contacted with the printing media 119 so that a moving direction of the printing media 119 inside the reversion module 105 is fixed. The housing 201 is used to put in the printing media 119 fed in the reversion module 105, and is used to drive a whole rotation of the reversion module 105 with a rotation of the housing 201 itself. The first rollers 203 is used to exert a normal force on the printing media 119 so that the moving direction of the printing media 119 is fixed, and the moving direction is a forward direction or a backward direction of the printing media 119. A driving force is exerted on the second rollers 205 by the second motor 117 in FIG. 1 and is transmitted through the second gear 213. And a forward movement or a backward movement of the printing media 119 is driven by a rotation of the second rollers 205, which are making use of the normal force that the first rollers 203 exert on the printing media 119. A driving force is exerted on the first axis 207 by the first motor 115 and is transmitted through the first gear 209, and the driving force is again exerted on the housing 201 by the first axis 207 to drive a rotation of the housing 201. The second axis 211 is used to balance the driving force exerted by the first motor 115 to fix the rotating direction of the housing 201 while the housing 201 is rotated.

Please refer to FIG. 1 and FIG. 2 again. Before making the second side of the printing media 119 face up in the view of FIG. 1 for performing a double-sided printing, the printing media 119 is fed into the housing 201 of the reversion module 105 with the first side of the printing media 119 facing up. The stick 107 is fixed on the cylindrical structure 131 of the reversion module 105, and the reversion module 105 is fixed by the stick 107 at this time. Therefore, the reversion module 105 is unable to be rotated. Then, a rotation of the second rollers 205 is driven by the second motor 117 through the second gear 213. A friction force generated between the second rollers 205 and the printing media 119 is also used to drive the printing media 119 forward from outside the housing 201 to inside the housing 201. During the process of the printing media 119 being driven by the second motor 117, a normal force on the printing media 119 is exerted by the first rollers 203 to fix the moving direction of the printing media 119. Next, the printing media 119 is driven to a first designated position by the second motor 117, and the first designated position is an appropriate position for the printing media 119 to be rotated. When the first sensor 111 detects that the printing media 119 is driven to the first designated position, the second motor 117 ceases driving the printing media 119. The stick 107 is driven by the first motor 115 through the first gear 209 and is released from the cylindrical structure 131 of the reversion module 105 to release the reversion module 105 so that the reversion module 105 is rotatable at this time. In the meanwhile, a driving force is also transmitted to the first axis 207 by the first motor 115 through the first gear 209. Therefore, a rotation of the housing 201 can be driven by the first axis 207. And a normal force, which is exerted by the first rollers 203 on the printing media 119, is also used to fix the printing media 119 inside the housing 201 so that the printing media 119 will not fall off the housing 201 by the rotation of the housing 201. After the second sensor 113 detects that the housing 201 has been rotated to a second designated position, the first motor 115 ceases driving the rotation of the housing 201. The second designated position is where the printing media 119 and the housing 201 are rotated a half turn from the first designated position. Since the housing 201 is driven by the first motor 115 to rotate a half turn from the first designated position, the printing media 119, which is fixed on the housing 201 by the first rollers 203, is also rotated a half turn so that the unprinted second side of the printing media 119 faces up in the view of FIG. 1 at this time. Next, the first motor 115 ceasing to drive the rotation of the housing 201, the stick 107 is also driven by the first motor 115 through the first gear 109 so that the stick 107 is fixed on the cylindrical structure 133. Therefore, the reversion module 105 is fixed by the stick 107 again and is unable to be rotated. Then a driving force is exerted on the second rollers 205 by the second motor 117 through the second gear 213 to make a movement of the printing media 119 so that the printing media 119 can be driven to outside of the housing 201 with a moving direction from inside of the housing 201 to outside of the housing 201. The unprinted second side of the printing media 119 faces up in the view of FIG. 1 at this time.

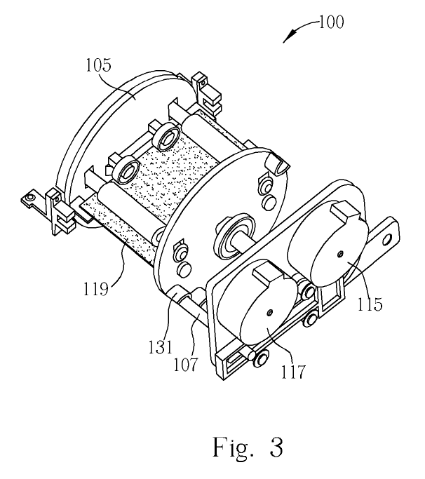

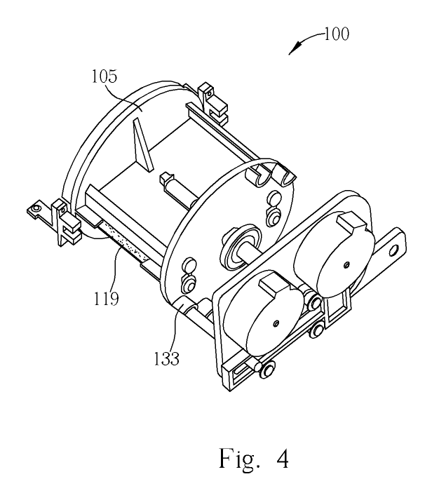

Please refer to FIG. 3 and FIG. 4. FIG. 3 is a diagram of the reversion module 105 of the printer 100 not being rotated nor being at the aforementioned first designated position of the present invention. FIG. 4 is a diagram of the reversion module 105 of the printer 100 being rotated a half turn from the aforementioned first designated position to the aforementioned second designated position. As shown in FIG. 3, the printing media 119 is fixed at the first designated position appropriate for the printing media 119 to be rotated. Then the reversion module 105 is rotated a half turn from the first designated position shown in FIG. 3 to the second designated position shown in FIG. 4. Not only the reversion module 105 but also the printing media 119 inside the reversion module 105 is rotated a half turn so that the previously faced-up first side of the printing media 119 faces down, and the previously faced-down second side of the printing media 119 faces up. As shown in FIG. 4, the reversed printing media 119 is covered by the reversion module 105 so that the printing media 119 is not shown in FIG. 4.

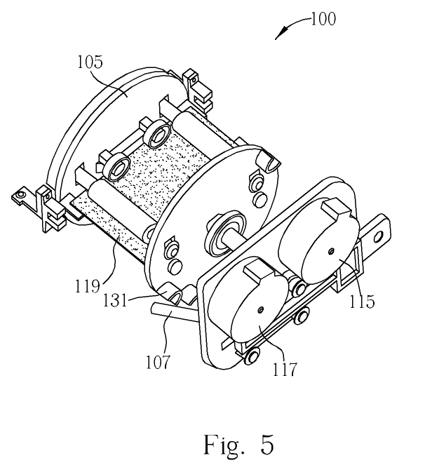

Please refer to FIG. 5, and refer to FIG. 3 again. In FIG. 3, the reversion module 105 of the printer 100 is fixed on the cylindrical structure 131 by the stick 107. FIG. 5 is a diagram of the reversion module 105 being released from the cylindrical structure 131 by the stick 107 in the printer 100 of the present invention. In FIG. 3 and FIG. 5, the reversion module 105 is at the aforementioned first designated position. As shown in FIG. 3, when the printing media is not yet rotated a half turn, the stick 107 is fixed on the cylindrical structure 131 of the reversion module 105 so that the reversion module 105 cannot be rotated. As shown in FIG. 5, when the printing media 119 is rotated a half turn from the first designated position to make the second side of the printing media 119 face up, the first motor 115 of FIG. 1 is required to drive a slide of the stick 107 through the first gear 209 of FIG. 2 so that the stick 107 is released from the cylindrical structure 131 of the reversion module 105 to release the reversion module 105. Therefore, the reversion module 105 can be rotated.

Please refer to FIG. 6, which is a diagram of the printing media 119 being directly ejected from the reversion module 105 when there is a defect on the printing media 119. Please refer to FIG. 1, FIG. 2, and FIG. 6. As shown in FIG. 6, the stick 107 is fixed on the cylindrical structure 135 of the reversion module 105. Therefore, the reversion module 105 tilts from the horizon and is fixed by the stick 107. Then the second gear 213 of FIG. 2 is driven by the second motor 117 of FIG. 1. Therefore, the printing media 119 can be driven to a position for departing from the reversion module 105 by the second rollers 205 coupled to the second gear 213 in a rotatable manner. Therefore, the printing media 119 can be ejected from the reversion module 105.

Compared with the single-sided media printer in the prior art, the double-sided media printer of the present invention can reverse a printing media without additional manual operations. Therefore, the unprinted second side of the printing media faces up in the double sided-printer of the present invention whereas the second side of the printing media cannot be printed directly in the single-sided media printer of the prior art. Therefore, the problem of the prior art single-sided media printer is solved in the present invention by reducing the time needed for manual operations. The problem of the prior art is the low efficiency caused by significantly increasing manual operations of reversing the printing media while processing huge amount of double-sided printing by the single-sided media printer of the prior art. The problem is solved by directly performing double-sided printing on the printing media with the double-sided media printer of the present invention. Moreover, since the position of the printing media being fed into the reversion module and the position of the reversion module being rotated is detected by respective sensors, the positions where the printing media is being driven and rotated are well located. Therefore, another problem of the prior art single-sided media printer is solved. The problem is caused by the second side of the printing media easily deviating from a designated position and is caused by the arrangement of the patterns of the first side and the second side of the printing media being inconsistent resulting from the reversing of the printing media by manual operations with the single-sided media printer of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A printer capable of printing double sides of a printing media comprising:
a shell having a cannelure disposed on the shell;
a reversion module disposed inside the shell in a rotatable manner with respect to the shell;
a stick having an end fixed on the cannelure in a slidable manner and having another end fitting a cylindrical structure of the reversion module;
a roller set utilized for driving the printing media while the reversion module is fixed within the shell;
a first sensor utilized for sensing whether the printing media is driven to a first default position;
a second sensor utilized for sensing whether the reversion module is rotated to a second default position;
a first motor utilized for driving the stick and the reversion module simultaneously; and
a second motor utilized for driving the roller set to drive the printing media.

2. The printer of claim 1, wherein the first motor is fixed on the shell.

3. The printer of claim 1, wherein the second motor is fixed on the shell.

4. The printer of claim 1, wherein each sensor comprises a light source and a light sensor.
